(19) United States
(12) Patent Application Publication
(10) Pub. No.: US 2016/0197445 A1
(43) Pub. Date: Jul. 7, 2016

(54) BUILDING SET FOR ORGANIZING ELECTRONIC ITEMS, OR ACCESSORIES

(71) Applicant: Zound Industries International AB, Stockholm (SE)

(72) Inventors: Susanne Bryngelsson, Stockholm (SE); Carl Johan Uggla, Stockholm (SE)

(21) Appl. No.: 14/966,956

(22) Filed: Dec. 11, 2015

Related U.S. Application Data
(60) Provisional application No. 62/099,294, filed on Jan. 2, 2015.

(51) Int. Cl. H01R 13/72; H01R 24/28; H01R 13/46

(52) U.S. Cl. CPC H01R 13/72; H01R 13/46; H01R 24/28

(57) ABSTRACT

The present disclosure generally concerns a building set for organizing electronic items, or accessories. The disclosure inter alia also presents power devices, memory devices, connector devices, etc. In one of its aspects, the disclosure presents a building set for organizing electronic items, or accessories, wherein the building set comprises a first building element and a second building element. The first building element is provided with coupling means of a first type and the second building element is provided with coupling means of a second type. The first and second types of coupling means are configured complementary in such a way that the coupling means of the first and second building elements can be releasably interconnected to the effect that they form a mechanical joint between the building elements.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This Patent Application claims the benefit of priority to Provisional U.S. of America Patent Application No. 62/099,294, filed on Jan. 2, 2015, the contents of which are hereby expressly incorporated by reference in its entirety.

### BACKGROUND

1. Field

The present disclosure generally concerns item organization. In particular, features for a building set for organizing electronic items, or accessories, are disclosed.

2. Description of the Related Art

Users use more and more electronic devices, including e.g. tablet computers, smartphones, media devices, etc. Since all these devices consume power, users typically also have to bring electronic items, or accessories, that are associated with the above-mentioned electronic devices. The electronic items, or accessories, may e.g. include memory devices (e.g., memory sticks such as Universal Serial Bus (USB) memory sticks, etc.), various cables such as cables for powering the electronic devices and/or cables such as earphone cables. Organization of such items is therefore needed. Current solutions to organizing such items are complex and inconvenient.

### SUMMARY

It is in view of the above considerations and others that the various embodiments of the present technology have been made. Generally, there is a need to improve the organization, or management, of the increasing number of electronic items, or accessories, that users carry.

The embodiments disclosed herein each have several aspects, no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems and methods for organizing electronic items.

In this disclosure, this building set will interchangeably be referred to as an electronic items building set.

The electronic items building set comprises a first building element and a second building element. The first building element is provided with coupling means of a first type and the second building element is provided with coupling means of a second type. The first and second types of coupling means are configured complementary in such a way that the coupling means of the first and second building elements can be releasably interconnected to the effect that they form a mechanical joint between the building elements.

The present disclosure also concerns a building block of an electronic items building set. At least one side of the building block is provided with coupling means adapted to cooperate with complementary coupling means of some associated building element.

Furthermore, various embodiments in the form of power devices, memory devices, clip devices, connector devices and carrying devices are presented.

In one of its aspects, the technology presented herein concerns an electronic items building set for organizing electronic items. The building set comprises a first building element and a second building element, wherein the first building element is provided with coupling means of a first type and the second building element is provided with coupling means of a second type. The first and second types of coupling means are configured complementary in such a way that the coupling means of the first and second building elements can be releasably interconnected to the effect that they form a mechanical joint between the building elements.

The coupling means of the first type may be a protrusion. The protrusion may e.g. be a projecting coupling stud.

The coupling means of the second type may be a cavity.

For example, the building set may be made of Thermoplastic polyurethane (TPU). Alternatively, the building set may e.g. be made of Silicon, Polypropylene (PP) also known as Polypropene, Rubber or Acrylonitrile butadiene styrene (ABS).

In another of its aspects, the technology presented herein concerns a building block of an electronic items building set for organizing electronic items, wherein the building set comprises building elements with coupling means for mutual mechanical joining of the building elements. At least one side of the building block is provided with coupling means adapted to cooperate with complementary coupling means of some associated building element.

Said coupling means may comprise at least one of a protrusion and a cavity.

A protrusion may be in the form of a projecting coupling stud.

A cavity may be in the form of a depression with respect to said at least one side of the building block. Typically, but not necessarily, the depth of said depression is smaller than the thickness of the building block.

For example, the building block may be made of Thermoplastic polyurethane (TPU). Alternatively, the building block may e.g. be made of Silicon, Polypropylene (PP) also known as Polypropene, Rubber or Acrylonitrile butadiene styrene (ABS).

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

These and other aspects, features and advantages will be apparent and elucidated from the following description of various embodiments, reference being made to the accompanying drawings, in which:

FIG. 1 shows various devices, or products, utilizing, the building set described throughout this disclosure;

FIGS. 2A-2D represent different views of one of the devices, or products, illustrated in FIG. 1;

FIGS. 3A-5B schematically illustrate various embodiments of a power device;

FIGS. 6A-6D schematically illustrates various views of a connector device that is adapted to be used together with the power devices shown in FIGS. 3-5;

FIGS. 7A-7E schematically illustrate different views of a clip device;

FIGS. 8A-8C schematically illustrate different views of a carrying device in accordance with an embodiment; and

FIGS. 9A-9B schematically illustrate different views of an alternative embodiment of a carrying device.

### DETAILED DESCRIPTION

The following detailed description is directed to certain specific embodiments of the development. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments.

Embodiments of the development will now be described with reference to the accompanying figures. The terminology used in the description presented herein is not intended to be interpreted in any limited or restrictive manner, simply because it is being utilized in conjunction with a detailed description of certain specific embodiments of the development. Furthermore, embodiments of the development may include several novel features, no single one of which is solely responsible for its desirable attributes or which is essential to practicing the invention described herein.

The technology will now be described more fully hereinafter. The technology may, however, be embodied in many different forms and should not be construed as limited to the embodiments set forth herein; rather, these embodiments are provided by way of example so that this disclosure will be thorough and complete, and will fully convey the scope of the technology to those persons skilled in the relevant art. Like reference numbers refer to like elements throughout the description.

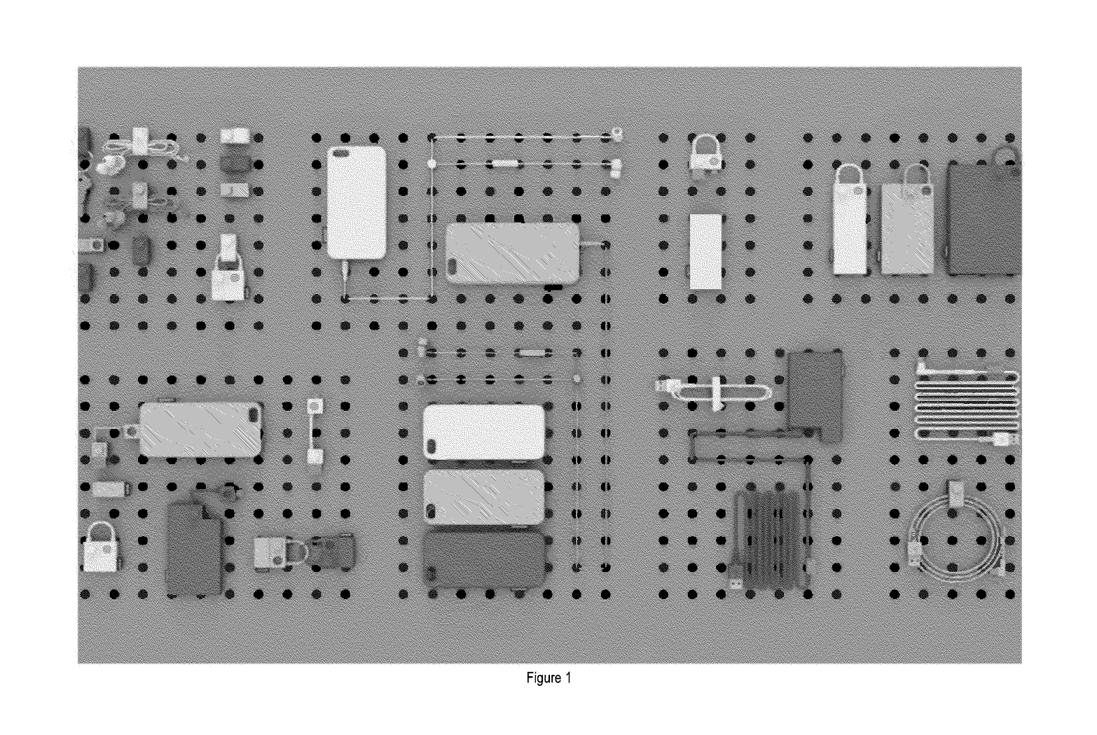

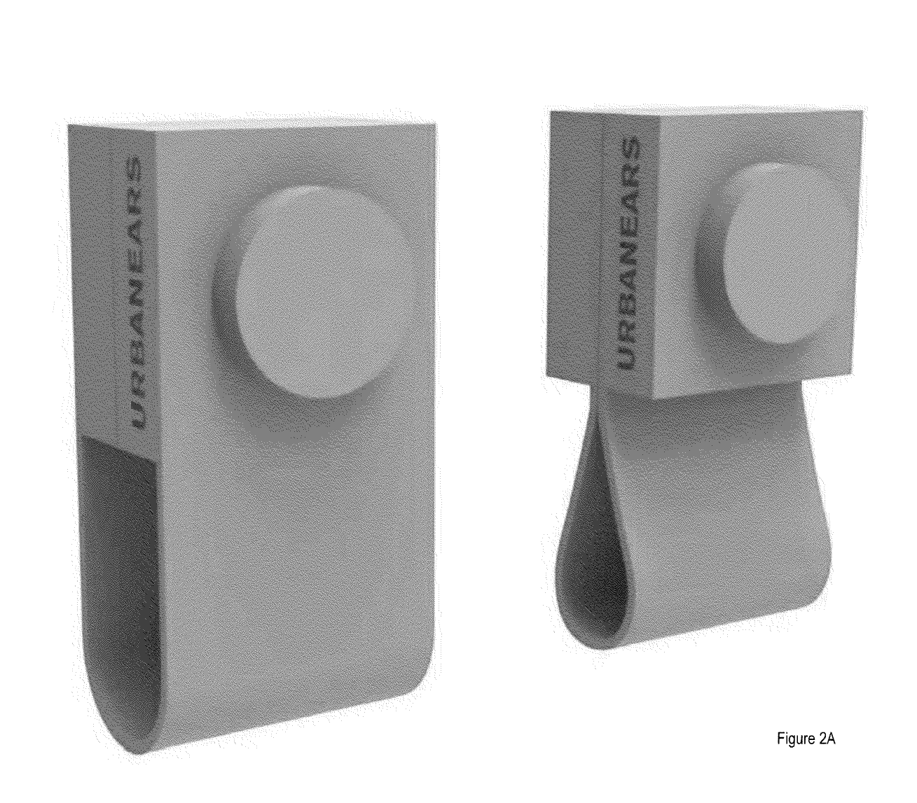

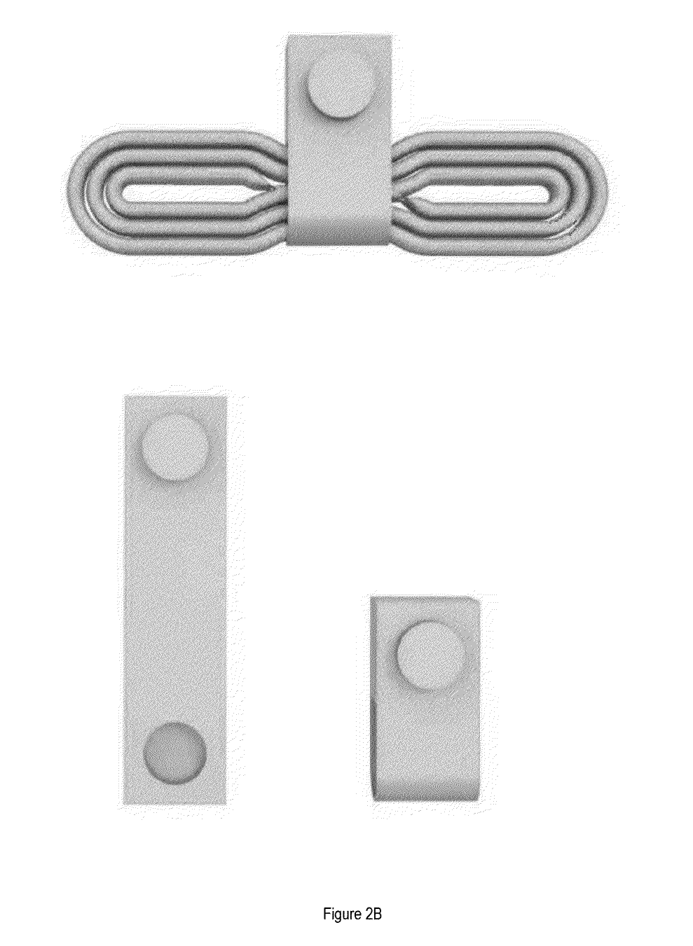

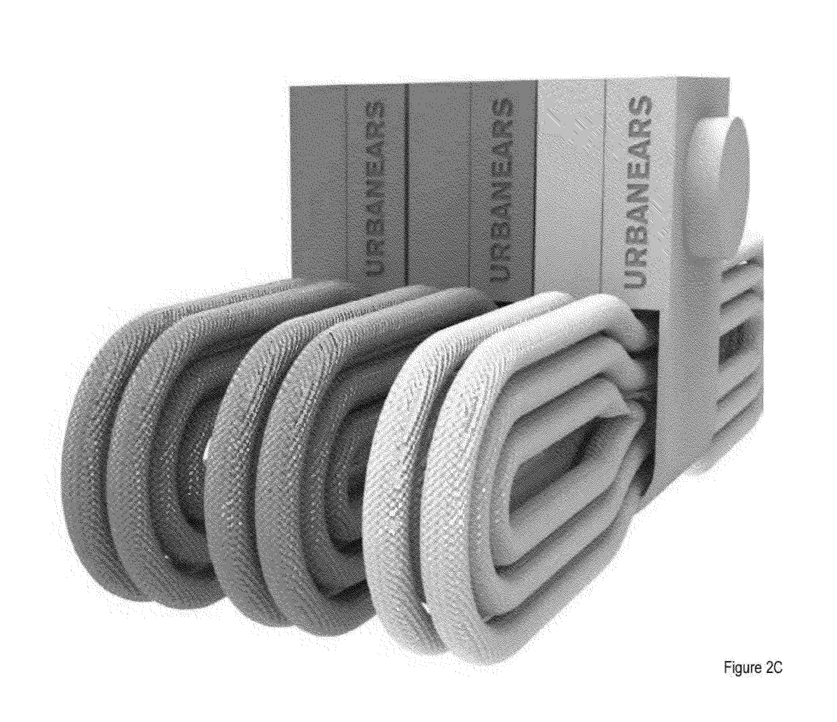

With reference to FIG. 1, different devices, or products, utilizing, the building set described throughout this disclosure is schematically illustrated. The electronic items building set is suitable for organizing electronic items, or accessories. With continued reference to FIG. 1 and with reference to FIGS. 2A-2D, the general concept of the building set will be further detailed.

Typically, but not necessarily, the building set comprises a first building element and a second building element, wherein the first building element is provided with coupling means of a first type and the second building element is provided with coupling means of a second type. The first and second types of coupling means are configured complementary in such a way that the coupling means of the first and second building elements can be releasably interconnected to the effect that they form a mechanical joint between the building elements.

As can e.g. be seen in FIGS. 2A-2D, the coupling means of the first type may be a protrusion. The protrusion may be a projecting coupling stud, e.g. having a predetermined contour (e.g., a circle as is illustrated in FIGS. 2A-2D). Furthermore, the coupling means of the second type may be a cavity. The cavity may e.g. be a depression having a predetermined contour (e.g., a circle as is illustrated in FIG. 2B) which is complementary with the corresponding contour of the earlier-mentioned protrusion. The cavity is adapted to receive the corresponding protrusion and can thus be releasably interconnected to the protrusion to the effect that the cavity-and-protrusion can form a mechanical joint between the building elements.

As will be appreciated, the building set may comprise various building blocks. As described hereinabove, the building set comprises building elements with coupling means for mutual mechanical joining of the building elements. Each building block of the building set may thus be characterized by at least one side provided with coupling means (e.g., at least one of a protrusion and a cavity) adapted to cooperate with complementary coupling means (e.g., protrusion or cavity) of some associated building element.

In the following, various embodiments of the technology will be further described.

### Power Device

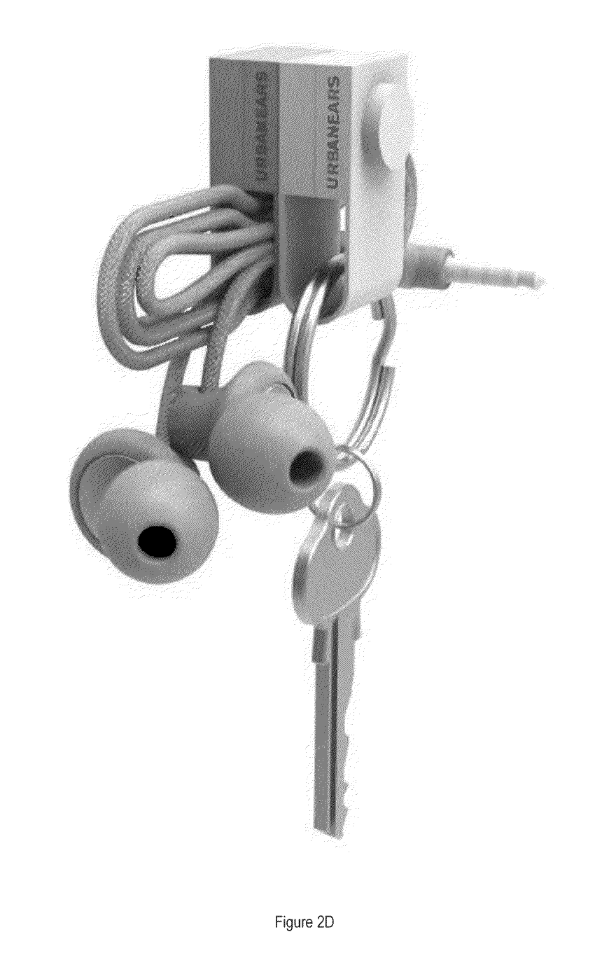

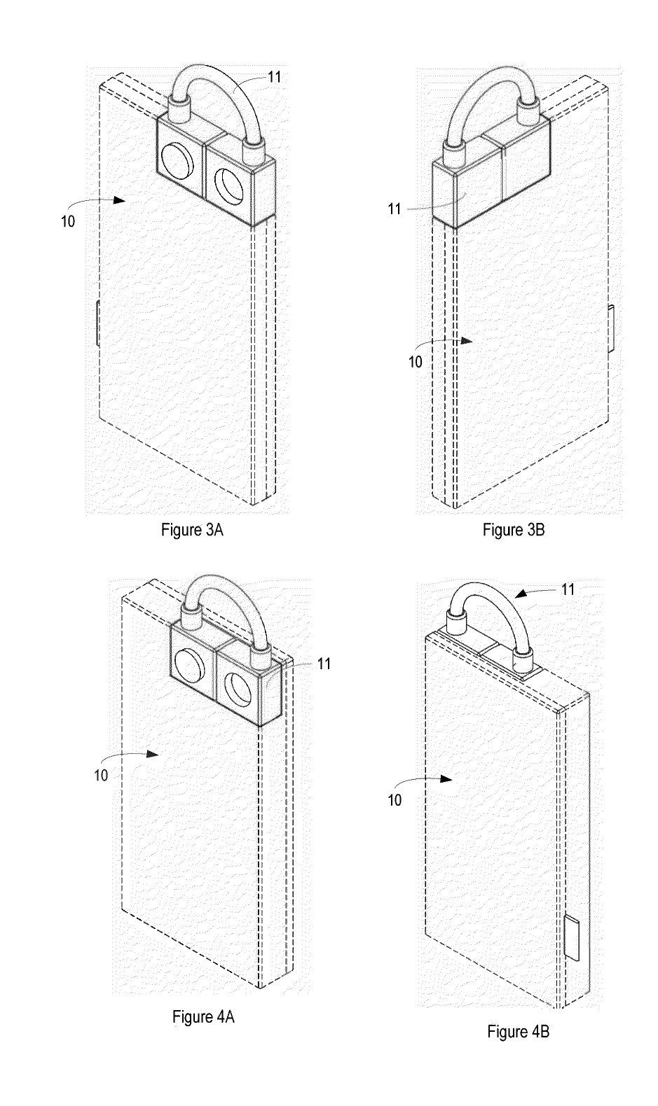

With reference to FIGS. 3-6, a power device will be described. A power device is sometimes referred to as a power bank, as it is typically used as a device for carrying extra, or additional, power. Thus, a fully (or partly) charged power device may be used to bring extra power to another electronic device (e.g., a tablet computer or smartphone) once this electronic device becomes discharged. Accordingly, if a user needs to keep his or her electronic devices charged on the go, he or she may additionally bring a fully or partly charged power device and use this power device to give the electronic device(s) extra power as needed, or on demand. Sometimes a power device is also interchangeably referred to as an external battery pack.

Power devices, as such, are known to those skilled in the relevant art and, in order not to obscure this disclosure with unnecessary detail, power devices will therefore not be described in further detail herein.

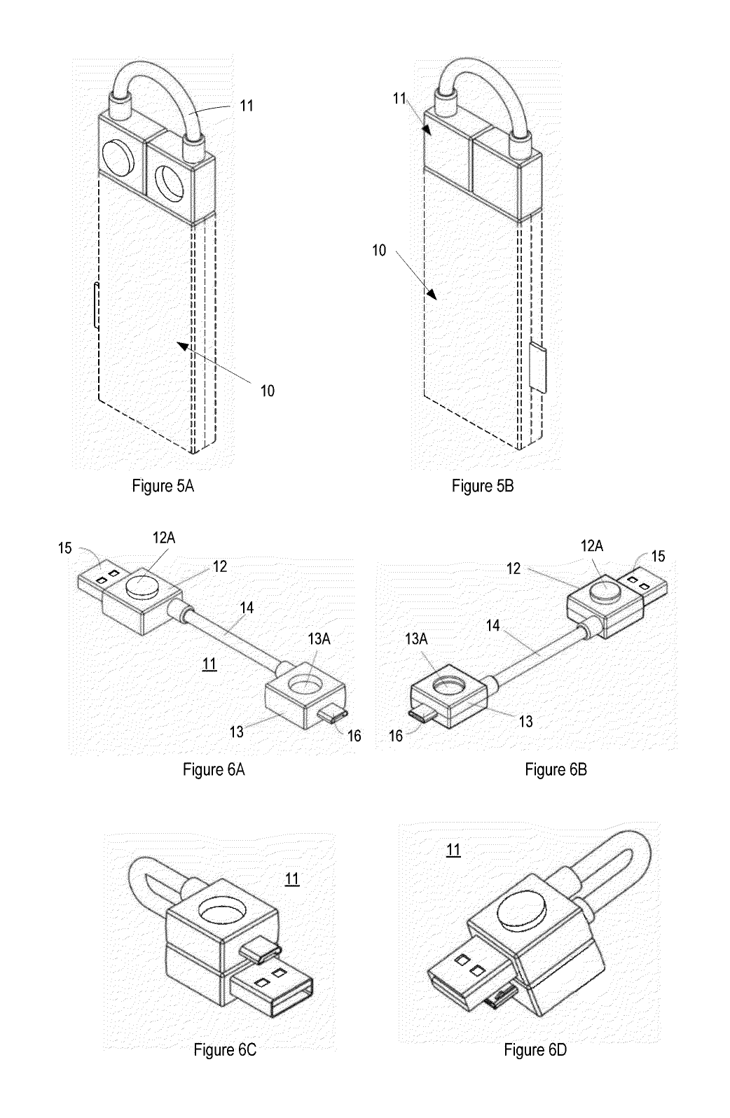

FIG. 3A schematically illustrates a front view of a first embodiment of a power device 10. FIG. 3B schematically illustrates a rear view of the power device 10 shown in FIG. 3A. A connector device 11 is releasably attached to the power device 10. Different views of the connector device 11 are schematically illustrated in FIGS. 6A-6D. FIGS. 4A-4B and FIGS. 5A-5B illustrate alternative embodiments of a power device 10.

With continued reference to FIGS. 6A-6D, the connector device 11 comprises a first end 12 and a second end 13. The first end 12 and the second end 13 may be interconnected by a cable 14, or wire.

The first end 12 is provided with coupling means of a first type, here exemplified by a protrusion 12A in the form of a projecting coupling stud having an essentially circular contour. Furthermore, the first end 12 comprises a first connector 15 (e.g. a USB connector) for connection, communication, and/or power supply between electronic devices.

The second end 13 is provided with coupling means of a second type, here exemplified by a cavity 13A having an essentially circular contour which is complementary with the earlier-mentioned contour of the protrusion.

The first and second types of coupling means are configured complementary in such a way that the coupling means of the first and second ends can be releasably interconnected to the effect that they form a mechanical joint between the first and second ends, see FIGS. 6C-6D. For example, the first end 12 may comprise a projecting coupling stud 12A having an essentially circular contour, which can be received by a cavity 13A of the second end 13 whose contour is also essentially circular.

Furthermore, the second end 13 comprises a second connector 16 for connection, communication, and/or power supply between electronic devices. The second connector 16 may be of the same type as the first connector 15. Alternatively, the second connector 16 is of a different type than the first connector 15. For example, the second connector 16 may be a Firewire connector.

Other connectors than those exemplified above (i.e., USB and Firewire) are of course conceivable. Micro USB, Mini USB, Thunderbolt, and Lightning are a few examples of alternative connectors.

The first and second connectors 15, 16, respectively, are adapted to be received by corresponding cavities, recesses, or holes provided at the power device 10 in such a way that the connector device 11 can be releasably connected to the power device 10, see FIGS. 3, 4 and 5, respectively. As will be appreciated by those skilled in the relevant art, when one connector is releasably connected to the power device 10 the other connector may be releasably connected to (or, plugged into) an electronic device (not shown) to e.g. enable the charging of the electronic device (not shown).

As can be seen in FIGS. 3-5, the cable 14 may form a loop, or is capable of forming a loop, when the two connectors are releasably connected to the power device 10. For example, a user may hence wear the power device 10 by hanging the thus formed loop in one of the loops generally provided at the waist portion of a pair of trousers. As will be appreciated, the user may hang, or hook, the formed loop (i.e., the cable) in other loops or devices (e.g. bags, soft cases, hard cases) too.

### Memory Device

A power device 10 has been described with respect to FIGS. 3-6. Alternatively, the power device 10 may be embodied as a memory device 10. A memory device may sometimes be referred to as an external storage device or external memory device. A memory device may e.g. be used to temporarily store data or information and can be used together with other electronic devices. Additionally, or alternatively, a memory device may be used as a device for carrying extra, or additional, memory. This may be particularly useful if the user carries other electronic devices with limited, or scarce, memory capacity.

### Clip Device

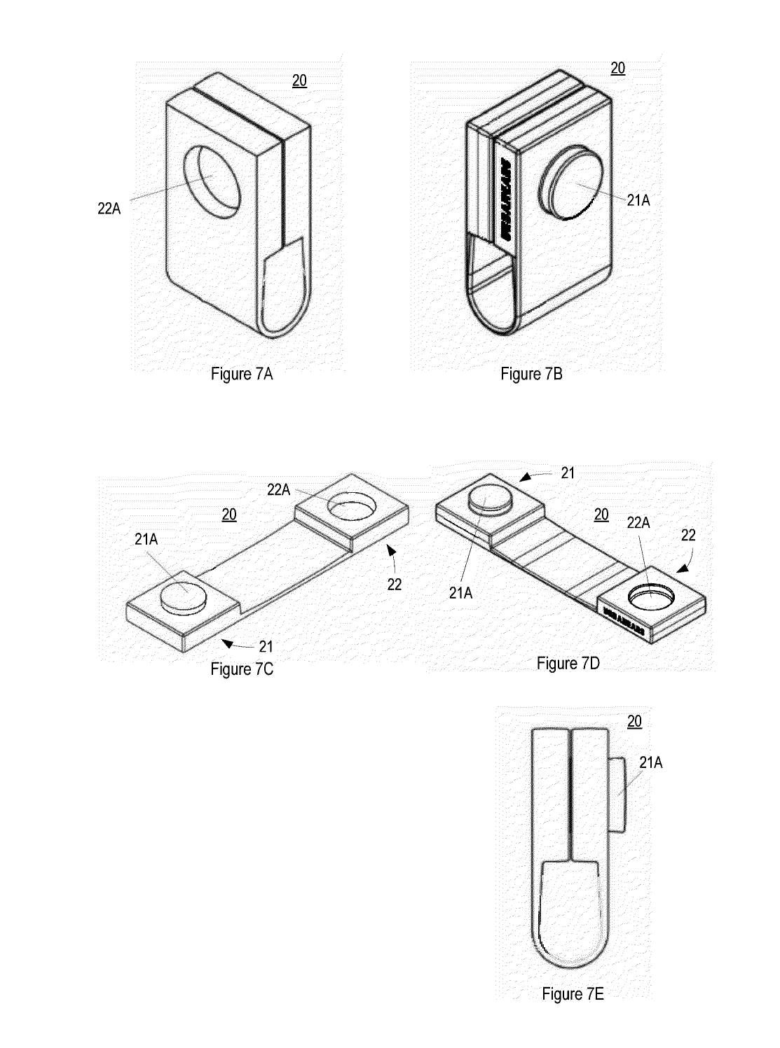

With reference to FIGS. 7A-E, a clip, or clip device 20, will be described. The clip device 20 is particularly suitable for cable management since it may be used to manage, or organize, cables such as cables for powering electronic devices and/or cables such as earphone cables, see e.g. FIGS. 2A-2B.

As will be appreciated by those skilled in the relevant art, the clip device 20 may also be used to carry other items than electronic items, or accessories. One such example of a non-electronic item is a key ring, see e.g. FIG. 2D.

Turning now to FIGS. 7A-7E, a clip device 20 will be described in further detail. The clip device 20 comprises a first end 21 and a second end 22. The second end 22 may be opposite to the first end 21. As can be seen in FIGS. 7C and 7D, the first end 21 is provided with coupling means 21A of a first type. The coupling means 21A of the first type may e.g. be a protrusion. This protrusion may be protrusion is a projecting coupling stud, e.g. having an essentially circular contour. Also, the second end 22 is provided with coupling means 22A of a second type. The coupling means 22A of the second type may e.g. be a cavity. This cavity may e.g. be a depression with respect to the second side 22 of the clip device 20. The depth of said depression may be smaller than the thickness of the second side 22. Furthermore, the cavity 22A may have a circular contour, as is illustrated in FIGS. 7A, 7C and 7D.

The first and second types of coupling means 21A, 22A are configured complementary in such a way that the coupling means 21A, 22A of the first and second ends 21, 22 can be releasably interconnected to the effect that they can form a mechanical joint between the ends and thereby form a loop of the clip device, see e.g. FIGS. 7A, 7B, and 7E.

The clip device 20 is preferably made of a plastic material, or other flexible or bendable material. For example, the clip device 20 may be made of Thermoplastic polyurethane (TPU). Alternatively, the clip device 20 may e.g. be made of Silicon, Polypropylene (PP) also known as Polypropene, Rubber or Acrylonitrile butadiene styrene (ABS).

As is illustrated in FIGS. 2C and 2D, several clip devices 20 may be releasably attached to each other to form a series of multiple clip devices 20. This allows a user to manage, or organize, several cables and/or other devices.

### Carrying Device

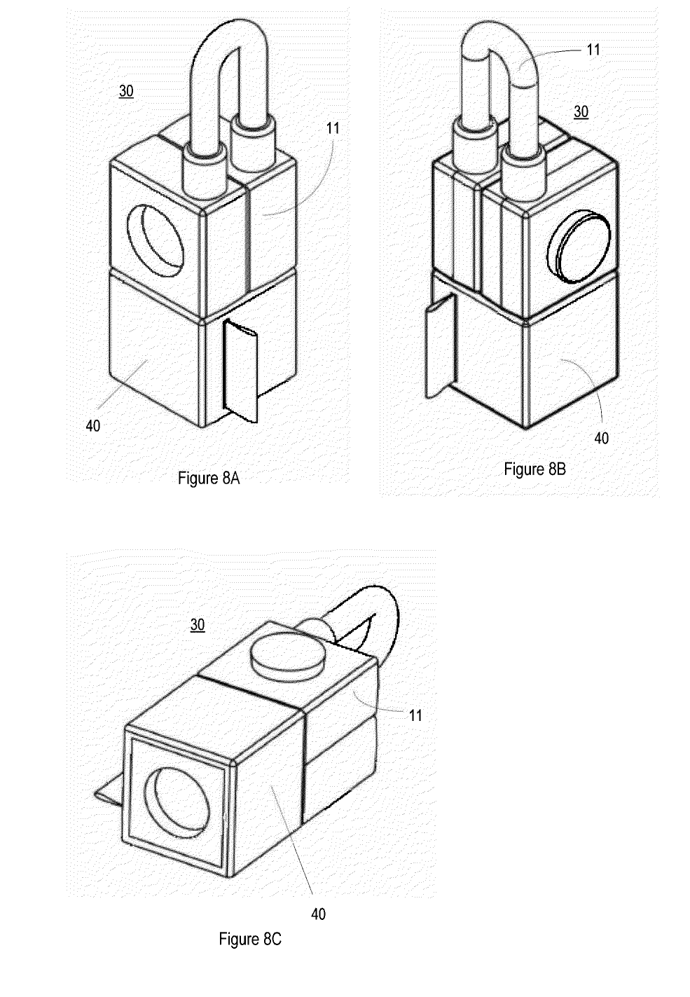

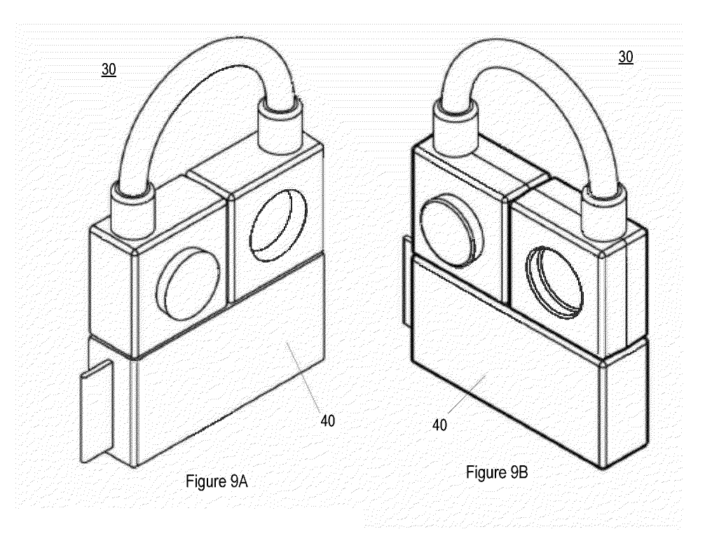

With reference to FIGS. 8A-C, a device 30, which will be referred to as a carrying device, will be described. The carrying device 30 is so called because it may be particularly suitable for carrying or bringing a connector device 11 which is useful together with other electronic devices (e.g. tablet computers, smart phones, power devices 10, memory devices 10, etc).

The connector device 11 (which is also illustrated in FIGS. 6A-6D) is releasably attachable to a building block 40 of a building set for organizing electronic items, or accessories.

With reference to FIGS. 6A-6D, the connector device 11 illustrated in FIGS. 8A-8C comprises a first end 12 and a second end 13. The first end 12 and the second end 13 may be interconnected by a cable 14, or wire.

The first end 12 is provided with coupling means of a first type, e.g. a protrusion 12A in the form of a projecting coupling stud having an essentially circular contour. Furthermore, the first end 12 comprises a first connector 15 (e.g. a USB connector) for connection, communication, and/or power supply between electronic devices. The second end 13 is provided with coupling means of a second type, e.g. a cavity 13A having an essentially circular contour which is complementary with the earlier-mentioned contour of the protrusion. The second end 13 comprises a second connector 16 for connection, communication, and/or power supply between electronic devices. The second connector 16 may be of the same type as the first connector 15. Alternatively, the second connector is of a different type. For example, the second connector 16 may be a Firewire connector. Other connectors than those exemplified above (i.e., USB and Firewire) are of course conceivable. Micro USB, Mini USB, Thunderbolt, and Lightning are examples of some alternative connectors.

The first and second types of coupling means are configured complementary in such a way that the coupling means of the first and second ends can be releasably interconnected to the effect that they form a mechanical joint between the first and second ends, see FIGS. 6C-6D. For example, the first end 12 may comprise a projecting coupling stud 12A having an essentially circular contour, which can be received by a cavity 13A of the second end 13 whose contour is also essentially circular.

The first and second connectors 15, 16, respectively, are adapted to be received by corresponding cavities, recesses, or holes provided at the building block 40 in such a way that the connector device 11 can be releasably connected to the building block 40, see FIGS. 8A-8C.

As is illustrated in FIGS. 8A-8C, the cable 14 may form a loop, or is capable of forming a loop, when the two connectors are releasably connected to the building block 40. For example, a user may hence wear the carrying device by hanging the thus formed loop in one of the loops generally provided at the waist portion of a pair of trousers. As will be appreciated, the user may hang, or hook, the formed loop (i.e., the cable) in other loops or devices (e.g., bags, soft cases, hard cases) too.

The building block 40 described hereinabove may include one or several devices of the group comprising: a mere building block for receiving the connectors of the connector device 11, a flashlight device, a memory device, a power device e.g. a charger device, a keyring accessory, a transformer device, a travel adapter device, a bike light device, a car charger device, a remote control device, a Global Positioning System (GPS) device, etcetera.

FIGS. 9A-9C illustrate an alternative embodiment of a carrying device 30, where the building block 40 take a different form, or design.

### Selected Example Embodiments

The technology disclosed herein thus encompasses without limitation the following non-limiting Numbered Example Embodiments (NEE):

NEE1. An electronic items building set for organizing electronic items, the building set comprising a first building element and a second building element, wherein the first building element is provided with coupling means of a first type and the second building element is provided with coupling means of a second type, wherein the first and second types of coupling means are configured complementary in such a way that the coupling means of the first and second building elements can be releasably interconnected to the effect that they form a mechanical joint between the building elements.

NEE2. The electronic items building set of NEE1, wherein the coupling means of the first type is a protrusion.

NEE3. The electronic items building set of NEE2, wherein said protrusion is a projecting coupling stud.

NEE4. The electronic items building set of any one of NEE's1-3, wherein the coupling means of the second type is a cavity.

NEE5. A building block of an electronic items building set for organizing electronic items, the building set comprising building elements with coupling means for mutual mechanical joining of the building elements, the building block being characterized in that at least one side of the building block is provided with coupling means adapted to cooperate with complementary coupling means of some associated building element.

NEE6. The building block of NEE5, wherein the coupling means comprise at least one of a protrusion and a cavity.

NEE7. The building block of NEE6, wherein said protrusion is a projecting coupling stud.

NEE8. The building block of any of NEE's5-7, wherein said cavity is a depression with respect to said at least one side of the building block, the depth of said depression being smaller than the thickness of the building block.

NEE9. A connector device releasably attachable to a portable power device, the connector device comprising:
a first end having a first connector; and
a second end with a second connector, wherein the first end and the second end are interconnected by a cable; the connector device being characterized in that the first end is provided with coupling means of a first type; and
the second end is provided with coupling means of a second type, wherein the first and second types of coupling means are configured complementary in such a way that the coupling means of the first and second ends can be releasably interconnected to the effect that they form a mechanical joint between the ends.

NEE10. The connector device of NEE9, wherein the coupling means of the first type is a protrusion.

NEE11. The connector device of NEE10, wherein said protrusion is a projecting coupling stud.

NEE12. The connector device of any of NEE's9-11, wherein the coupling means of the second type is a cavity.

NEE13. The connector device of any one of the NEE's9-12, wherein the first connector and the second connector are of a same type.

NEE14. The connector device of NEE13, wherein the first connector and the second connector are a USB connector.

NEE15. The connector device of NEE13, wherein the first connector and the second connector are a Firewire connector.

NEE16. The connector device of any one of the NEE's9-12, wherein the first connector and the second connector are of different types.

NEE17. The connector device of NEE16, wherein the first connector is a USB connector and the second connector is a Firewire connector.

NEE18. The connector device of NEE16, wherein the first connector is a Firewire connector and the second connector is a USB connector.

NEE19. A connector device releasably attachable to a portable memory device, the connector device comprising:
a first end having a first connector; and
a second end with a second connector, wherein the first end and the second end are interconnected by a cable; the connector device being characterized in that the first end is provided with coupling means of a first type; and
the second end is provided with coupling means of a second type, wherein the first and second types of coupling means are configured complementary in such a way that the coupling means of the first and second ends can be releasably interconnected to the effect that they form a mechanical joint between the ends.

NEE20. The connector device of NEE19, wherein the coupling means of the first type is a protrusion.

NEE21. The connector device of NEE20, wherein said protrusion is a projecting coupling stud.

NEE22. The connector device of any of the NEE's19-21, wherein the coupling means of the second type is a cavity.

NEE23. The connector device of any one of the NEE's19-22, wherein the first connector and the second connector are of a same type.

NEE24. The connector device of NEE23, wherein the first connector and the second connector are a USB connector.

NEE25. The connector device of NEE23, wherein the first connector and the second connector are a Firewire connector.

NEE26. The connector device of any one of the NEE's19-22, wherein the first connector and the second connector are of different types.

NEE27. The connector device of NEE26, wherein the first connector is a USB connector and the second connector is a Firewire connector.

NEE28. The connector device of NEE26, wherein the first connector is a Firewire connector and the second connector is a USB connector.

NEE29. A clip device comprising a first end and a second end, the clip device being characterized in that the first end is provided with coupling means of a first type and in that the second end is provided with coupling means of a second type, wherein the first and second types of coupling means are configured complementary in such a way that the coupling means of the first and second ends can be releasably interconnected to the effect that they can form a mechanical joint between the ends and form a loop of the clip device.

NEE30. The clip device of NEE29, wherein the coupling means of the first type is a protrusion.

NEE31. The clip device of NEE30, wherein said protrusion is a projecting coupling stud.

NEE32. The clip device of any of the NEE's29-31, wherein the coupling means of the second type is a cavity.

NEE33. The clip device of any one of the NEE's29-32, wherein the clip device is made of a plastic.

NEE34. A connector device releasably attachable to a building block of a building set for organizing electronic items, the connector device comprising:
a first end having a first connector; and
a second end with a second connector, wherein the first end and the second end are interconnected by a cable; the connector device being characterized in that the first end is provided with coupling means of a first type; and
the second end is provided with coupling means of a second type, wherein the first and second types of coupling means are configured complementary in such a way that the coupling means of the first and second ends can be releasably interconnected to the effect that they form a mechanical joint between the ends.

NEE35. The connector device of NEE34, wherein the coupling means of the first type is a protrusion.

NEE36. The connector device of NEE35, wherein said protrusion is a projecting coupling stud.

NEE37. The connector device of any of the NEE's34-36, wherein the coupling means of the second type is a cavity.

NEE38. The connector device of any one of the NEE's34-37, wherein the first connector and the second connector are of a same type.

NEE39. The connector device of NEE38, wherein the first connector and the second connector are a USB connector.

NEE40. The connector device of NEE38, wherein the first connector and the second connector are a Firewire connector.

NEE41. The connector device of any one of the NEE's34-37, wherein the first connector and the second connector are of different types.

NEE42. The connector device of NEE41, wherein the first connector is a USB connector and the second connector is a Firewire connector.

NEE43. The connector device of NEE41, wherein the first connector is a Firewire connector and the second connector is a USB connector.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the disclosure. As used herein, the terms “comprise/comprises” or “include/includes” do not exclude the presence of other elements or steps. Furthermore, although individual features may be included in different numbered example embodiments, these may possibly advantageously be combined, and the inclusion of different numbered example embodiments does not imply that a combination of features is not feasible and/or advantageous. In addition, singular references do not exclude a plurality.

What is claimed is:

1. A connector device releasably attachable to a portable power device, the connector device comprising:
a first end having a first connector; and
a second end with a second connector, wherein the first end and the second end are interconnected by a cable; the connector device being characterized in that
the first end is provided with coupling means of a first type; and
the second end is provided with coupling means of a second type, wherein the first and second types of coupling means are configured complementary in such a way that the coupling means of the first and second ends can be releasably interconnected to the effect that they form a mechanical joint between the ends.

2. The connector device of claim 1, wherein the coupling means of the first type is a protrusion.

3. The connector device of claim 2, wherein said protrusion is a projecting coupling stud.

4. The connector device of claim 1, wherein the coupling means of the second type is a cavity.

5. The connector device of claim 1, wherein the first connector and the second connector are of a same type.

6. The connector device of claim 1, wherein the first connector and the second connector are a USB connector.

7. The connector device of claim 5, wherein the first connector and the second connector are a Firewire connector.

8. The connector device of claim 1, wherein the first connector and the second connector are of different types.

9. The connector device of claim 8, wherein the first connector is a USB connector and the second connector is a Firewire connector.

10. The connector device of claim 9, wherein the first connector is a Firewire connector and the second connector is a USB connector.

11. The connector device of claim 1, wherein the power device is a power bank used for carrying extra, or additional, power.

12. The connector device of claim 1, wherein the power device is an external battery pack.
